(19) United States
(12) Patent Application Publication
(10) Pub. No.: US 2015/0293708 A1
(43) Pub. Date: Oct. 15, 2015

(54) Connectivity-Aware Storage Controller Load Balancing

(71) Applicant: NetApp, Inc., Sunnyvale, CA (US)

(72) Inventors: Dean Lang, Wichita, KS (US); Martin Jess, Erie, CO (US)

(73) Assignee: NetApp, Inc., Sunnyvale, CA (US)

(21) Appl. No.: 14/251,082

(22) Filed: Apr. 11, 2014

(51) Int. Cl. G06F 3/06

(52) U.S. Cl. CPC G06F 3/0613; G06F 3/0689; G06F 3/0617; G06F 3/0665; G06F 3/067; G06F 2003/0692

(57) ABSTRACT

A system and method for connectivity-aware assignment of volumes among the storage controllers of a storage system is provided. In some embodiments, during a discovery phase, a connectivity metric is determined from a device discovery command. The connectivity metric is recorded into a data structure that identifies a plurality of hosts and a plurality of storage controllers of a storage system. In response to the determining of the connectivity metric, a storage controller ownership of a first volume is changed to improve connectivity between a host of the plurality of hosts and the first volume. In some such embodiments, a storage controller ownership of a second volume is changed to balance load among the plurality of storage controllers, and the discovery phase is, in part, a response to the change in the storage controller ownership of the second volume.

### TECHNICAL FIELD

The present description relates to data storage and retrieval and, more specifically, to load balancing that accounts for conditions of network connections between hosts and the storage system being balanced.

### BACKGROUND

Networks and distributed storage allow data and storage space to be shared between devices located anywhere a connection is available. These implementations may range from a single machine offering a shared drive over a home network to an enterprise-class cloud storage array with multiple copies of data distributed throughout the world. Larger implementations may incorporate Network Attached Storage (NAS) devices, Storage Area Network (SAN) devices, and other configurations of storage elements and controllers in order to provide data and manage its flow. Improvements in distributed storage have given rise to a cycle where applications demand increasing amounts of data delivered with reduced latency, greater reliability, and greater throughput. Building out a storage architecture to meet these expectations enables the next generation of applications, which is expected to bring even greater demand.

In order to provide storage solutions that meet a customer's needs and budget, it is not sufficient to blindly add hardware. Instead, it is increasingly beneficial to seek out and reduce bottlenecks, limitations in one aspect of a system that prevent other aspects from operating at their full potential. For example, a storage system may include several storage controllers each responsible for interacting with a subset of the storage devices in order to store and retrieve data. To the degree that the storage controllers are interchangeable, dividing frequently accessed storage volumes across controllers may reduce the load on the most heavily burdened controller and thereby improve performance. However, not all storage controllers are equal or equally situated. Factors particular to the storage system as well as aspects external to the system may affect the performance of each controller differently. As merely one example, a host may have a better network connection (e.g., more direct, greater bandwidth, lower latency, etc.) to a particular storage controller.

Therefore, in order to provide optimal data storage performance, a need exists for techniques to optimize allocation of interchangeable resources such as storage controllers that are cognizant of a wide-range of performance factors. In particular, systems and methods for storage controller allocation that consider both controller load and the network environment have the potential to reduce bottlenecks and thereby improve data storage and retrieval speeds. Thus, while existing techniques for storage device allocation have been generally adequate, the techniques described herein provide improved performance and efficiency.

### BRIEF DESCRIPTION OF THE DRAWINGS

The present disclosure is best understood from the following detailed description when read with the accompanying figures.

FIG. 1 is a schematic diagram of an exemplary storage architecture according to aspects of the present disclosure.

FIG. 2 is a flow diagram of a method of reassigning volumes among storage controllers according to aspects of the present disclosure.

FIG. 3 is an illustration of a performance-tracking database according to aspects of the present disclosure.

FIG. 4 is an illustration of a host connectivity database according to aspects of the present disclosure.

FIG. 5 is a schematic illustration of a storage architecture at a first point in time during a method of reassigning volumes according to aspects of the present disclosure.

FIG. 6 is a schematic illustration of a storage architecture at a second point in time during a method of reassigning volumes according to aspects of the present disclosure.

FIG. 7 is a flow diagram of a two-pass method of reassigning volumes among storage controllers according to aspects of the present disclosure.

### DETAILED DESCRIPTION

All examples and illustrative references are non-limiting and should not be used to limit the claims to specific implementations and embodiments described herein and their equivalents. For simplicity, reference numbers may be repeated between various examples. This repetition is for clarity only and does not dictate a relationship between the respective embodiments except where explicitly noted. Finally, in view of this disclosure, particular features described in relation to one aspect or embodiment may be applied to other disclosed aspects or embodiments of the disclosure, even though not specifically shown in the drawings or described in the text.

Various embodiments include systems and methods for reallocating ownership of data storage volumes to storage controllers according to connectivity considerations. Although the scope of embodiments is not limited to any particular use case, in one example, a storage system having two or more interchangeable storage controllers first determines a reassignment of volumes to storage controllers based on performance considerations such as load balancing. In the example, volumes are reassigned to separate heavily accessed volumes and thereby distribute the corresponding transaction requests across multiple storage controllers. The storage system then evaluates those volumes to be moved to determine whether the new storage controller has an inferior connection to the hosts that access the volume. If so, the reassignment may be canceled for the volume. When the reassignment has finalized, the storage system moves the volumes to the new storage controllers and transmits a message to each host indicating that the configuration of the system has changed. In response, the hosts begin a discovery process that includes requesting configuration information from the storage system. From the requests, the storage system can assess the connections or links between the hosts and the controllers. For example, the storage system may detect a new link or a link that has lost a connection. The storage system uses this connection information in subsequent volume reassignments. In some embodiments, the storage system collects the relevant connection information from a conventional host discovery process. Thus, the connection-aware reassignment technique may be implemented without any changes to the hosts.

In some examples, particularly those where reassignment is infrequent, more current connection information can be obtained by using a two-phase reassignment process. During the first phase, the volumes are reassigned based on performance considerations (and, in some cases, connection considerations). The volumes are moved to their new storage controllers, and the storage system informs the hosts. From the host response, the storage system assesses the connection status and begins the second-phase reassignment based on connection considerations (and, in some cases, performance considerations). Thus, in this technique, volumes may be moved twice as part of the same reassignment. However, in embodiments where the burden of volume reassignment is minimal, having more current connection information justifies the additional steps. It is understood that these features and advantages are shared among the various examples herein and that no one feature or advantage is required for any particular embodiment.

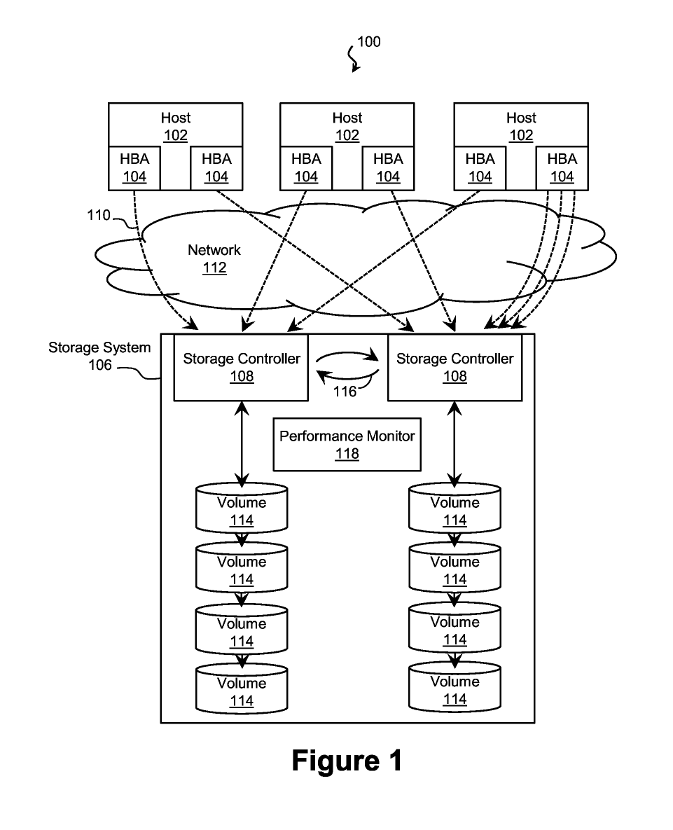

FIG. 1 is a schematic diagram of an exemplary storage architecture 100 according to aspects of the present disclosure. The storage architecture 100 includes a number of hosts 102 in communication with a number of storage systems 106. It is understood that for clarity and ease of explanation, only a single storage system 106 is illustrated, although any number of hosts 102 may be in communication with any number of storage systems 106. Furthermore, while the storage system 106 and each of the hosts 102 are referred to as singular entities, a storage system 106 or host 102 may include any number of computing devices and may range from a single computing system to a system cluster of any size. Accordingly, each host 102 and storage system 106 includes at least one computing system, which in turn includes a processor such as a microcontroller or a central processing unit (CPU) operable to perform various computing instructions. The computing system may also include a memory device such as random access memory (RAM); a non-transitory computer-readable storage medium such as a magnetic hard disk drive (HDD), a solid-state drive (SSD), or an optical memory (e.g., CD-ROM, DVD, BD); a video controller such as a graphics processing unit (GPU); a communication interface such as an Ethernet interface, a Wi-Fi (IEEE 802.11 or other suitable standard) interface, or any other suitable wired or wireless communication interface; and/or a user I/O interface coupled to one or more user I/O devices such as a keyboard, mouse, pointing device, or touchscreen.

With respect to the hosts 102, a host 102 includes any computing resource that is operable to exchange data with a storage system 106 by providing (initiating) data transactions to the storage system 106. In an exemplary embodiment, a host 102 includes a host bus adapter (HBA) 104 in communication with a storage controller 108 of the storage system 106. The HBA 104 provides an interface for communicating with the storage controller 108, and in that regard, may conform to any suitable hardware and/or software protocol. In various embodiments, the HBAs 104 include Serial Attached SCSI (SAS), iSCSI, InfiniBand, Fibre Channel, and/or Fibre Channel over Ethernet (FCoE) bus adapters. Other suitable protocols include SATA, eSATA, PATA, USB, and FireWire. In the illustrated embodiment, each HBA 104 is connected to a single storage controller 108, although in other embodiments, an HBA 104 is coupled to more than one storage controllers 108. Communications paths between the HBAs 104 and the storage controllers 108 are referred to as links 110. A link 110 may take the form of a direct connection (e.g., a single wire or other point-to-point connection), a networked connection, or any combination thereof. Thus, in some embodiments, one or more links 110 traverse a network 112, which may include any number of wired and/or wireless networks such as a Local Area Network (LAN), an Ethernet subnet, a PCI or PCIe subnet, a switched PCIe subnet, a Wide Area Network (WAN), a Metropolitan Area Network (MAN), the Internet, or the like. In many embodiments, a host 102 has multiple links 110 with a single storage controller 108 for redundancy. The multiple links 110 may be provided by a single HBA 104 or multiple HBAs 104. In some embodiments, multiple links 110 operate in parallel to increase bandwidth.

To interact with (e.g., read, write, modify, etc.) remote data, a host 102 sends one or more data transactions to the respective storage system 106 via a link 110. Data transactions are requests to read, write, or otherwise access data stored within a data storage device such as the storage system 106, and may contain fields that encode a command, data (i.e., information read or written by an application), metadata (i.e., information used by a storage system to store, retrieve, or otherwise manipulate the data such as a physical address, a logical address, a current location, data attributes, etc.), and/or any other relevant information.

Turning now to the storage system 106, the exemplary storage system 106 contains any number of storage devices (not shown) and responds to hosts' data transactions so that the storage devices appear to be directly connected (local) to the hosts 102. The storage system 106 may group the storage devices for speed and/or redundancy using a virtualization technique such as RAID (Redundant Array of Independent/Inexpensive Disks). At a high level, virtualization includes mapping physical addresses of the storage devices into a virtual address space and presenting the virtual address space to the hosts 102. In this way, the storage system 106 represents the group of devices as a single device, often referred to as a volume 114. Thus, a host 102 can access the volume 114 without concern for how it is distributed among the underlying storage devices.

In various examples, the underlying storage devices include hard disk drives (HDDs), solid state drives (SSDs), optical drives, and/or any other suitable volatile or non-volatile data storage medium. In many embodiments, the storage devices are arranged hierarchically and include a large pool of relatively slow storage devices and one or more caches (i.e., smaller memory pools typically utilizing faster storage media). Portions of the address space are mapped to the cache so that transactions directed to mapped addresses can be serviced using the cache. Accordingly, the larger and slower memory pool is accessed less frequently and in the background. In an embodiment, a storage device includes HDDs, while an associated cache includes NAND-based SSDs.

The storage system 106 also includes one or more storage controllers 108 in communication with the storage devices and any respective caches. The storage controllers 108 exercise low-level control over the storage devices in order to execute (perform) data transactions on behalf of the hosts 102, and in so doing, may present a group of storage devices as a single volume 114. In the illustrated embodiment, the storage system 106 includes two storage controllers 108 in communication with a set of volumes 114 created from a group of storage devices. A backplane connects the volumes 114 to the storage controllers 108, and where volumes 114 are coupled to two or more storage controllers 108, a single storage controller 108 may be designated the owner of each volume 114. In some such embodiments, only the storage controller 108 that has ownership of a volume 114 may directly read to or write from a volume 114. In the illustrated embodiment of FIG. 1, each storage controller 108 has ownership of those volumes 114 shown as connected to the controller 108.

If a transaction is received at a storage controller 108 that is not an owner, the transaction may be forwarded to the owning controller 108 via an inter-controller bus 116. Any response, such as data read from the volume 114 may then be communicated from the owning controller 108 to the receiving controller 108 across the inter-controller bus 116 where it is then sent on to the respective host 102. While this allows transactions to be performed regardless of which controller 108 receives them, traffic on the inter-controller bus 116 may create congestion delays if not carefully controlled.

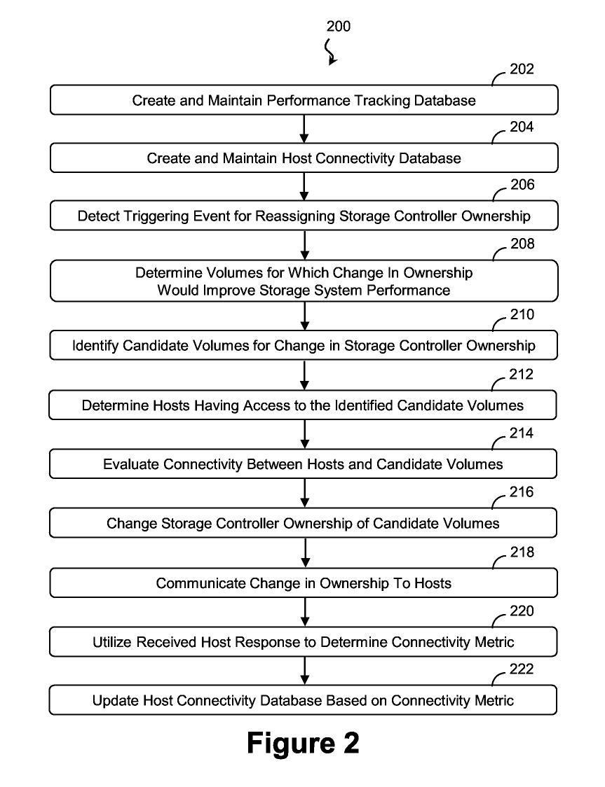

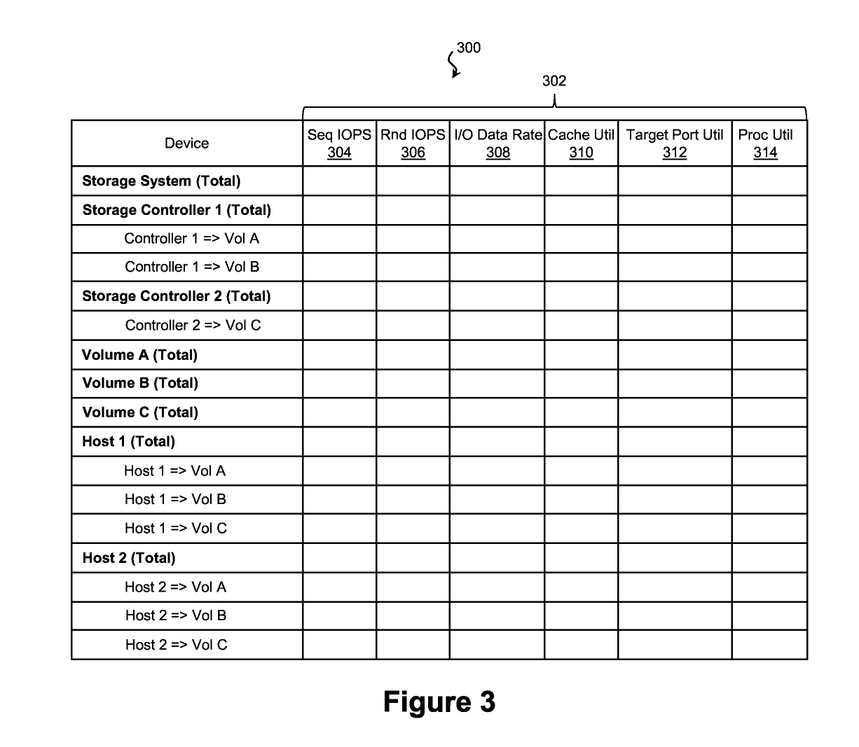

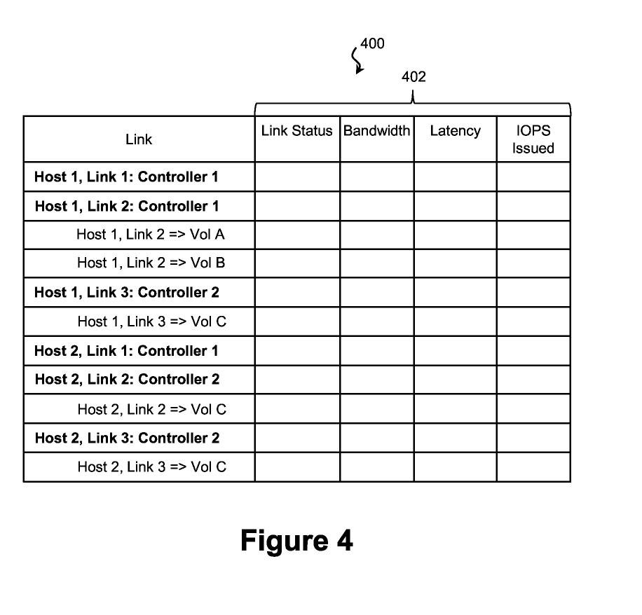

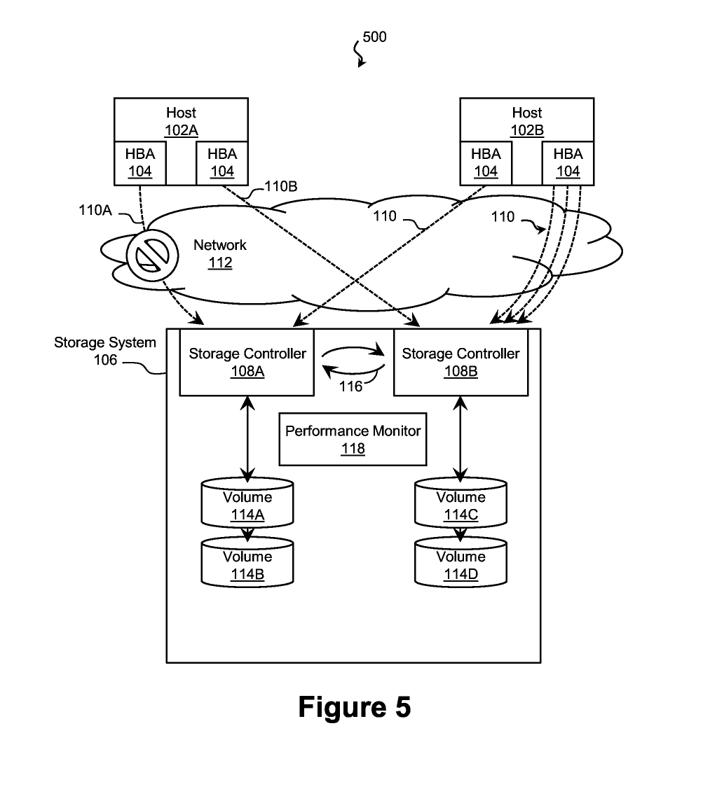

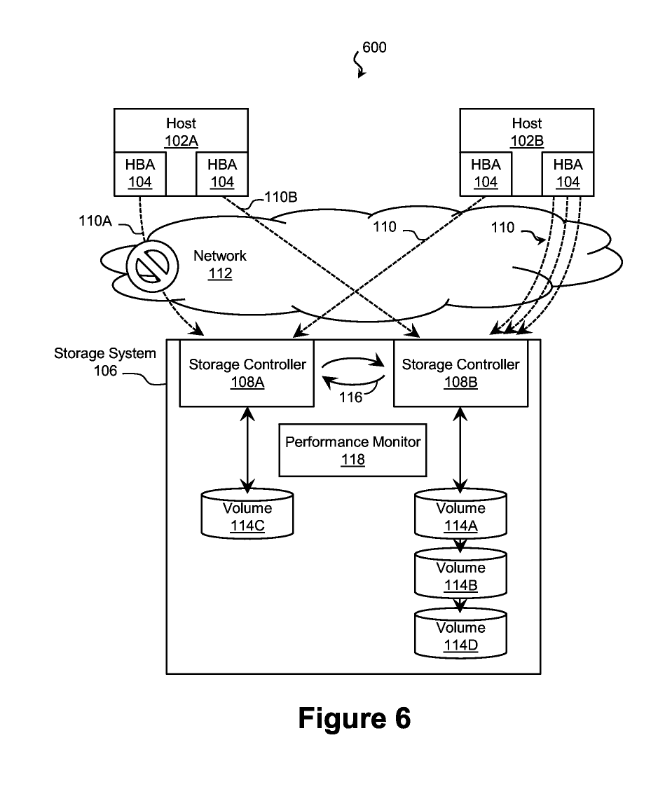

For this reason and others, ownership of the volumes 114 may be reassigned, and in many cases, reassignment can be performed without disrupting operation of the storage system 106 beyond a brief pause (a “quiesce”). In that regard, the storage controllers 108 are at least partially interchangeable. A system and method for reassigning volumes 114 among storage controllers 108 is described with reference to FIGS. 2-6. FIG. 2 is a flow diagram of the method 200 of reassigning volumes 114 among storage controllers 108 according to aspects of the present disclosure. It is understood that additional steps can be provided before, during, and after the steps of method 200, and that some of the steps described can be replaced or eliminated for other embodiments of the method. FIG. 3 is an illustration of a performance-tracking database 300 according to aspects of the present disclosure. FIG. 4 is an illustration of a host connectivity database 400 according to aspects of the present disclosure. FIG. 5 is a schematic illustration of a storage architecture 500 at a first point in time during the method of reassigning volumes according to aspects of the present disclosure. FIG. 6 is a schematic illustration of a storage architecture 600 at a second point in time during the method of reassigning volumes according to aspects of the present disclosure. In many respects, storage architecture 500 and storage architecture 600 may be substantially similar to storage architecture 100 of FIG. 1.

Referring first to block 202 of FIG. 2 and to FIG. 3, the storage system 106 creates and maintains a performance-tracking database 300. The performance-tracking database 300 records performance metrics 302 of the storage system 106. The performance metrics 302 are used, in part, to determine the optimal storage controller 108 to act as the owner of each particular volume 114. Accordingly, the performance metrics 302 include data relevant to this determination. For example, in the illustrated embodiment, the performance-tracking database 300 records the average number of Input/Output Operations Per Second (IOPS) experienced by a storage controller 108 or volume 114 over a recent interval of time. IOPS may be subdivided into Sequential IOPS 304 and Random IOPS 306, representing transactions directed to contiguous addresses and random addresses, respectively. The exemplary performance-tracking database 300 also records the average data transfer rate 308 for a storage controller 108 and for a volume 114 over a recent interval of time. Other exemplary performance metrics 302 include cache utilization 310, target port utilization 312, and processor utilization 314.

In some embodiments, the performance-tracking database 300 records performance metrics 302 specific to one or more hosts 102. For example, the performance-tracking database 300 may track the number of transactions or IOPS issued by a host 102 and may further subdivide the transactions according to the volumes 114 to which they are directed. In this way, the performance metrics 302 may be used to determine complex relationships between hosts 102 and volumes 114.

The performance-tracking database 300 may take any suitable format including a linked list, a tree, a table such as a hash table, an associative array, a state table, a flat file, a relational database, and/or other memory structure. The work of creating and maintaining the performance-tracking database 300 may be performed by any component of the storage architecture 100. For example, the performance-tracking database 300 may be maintained by one or more storage controllers 108 of the storage system 106 and may be stored on a memory element within one or more of the storage controllers 108. While maintaining the performance-tracking database 300 may consume modest processing resources, it may be I/O intensive. Accordingly, in a further embodiment, the storage system 106 includes a separate performance monitor 118 that maintains the performance-tracking database 300.

Referring to block 204 of FIG. 2 and to FIG. 4, the storage system 106 creates and maintains a host connectivity database 400. The host connectivity database 400 records connectivity metrics 402 for the interconnections between the HBAs 104 of the hosts 102 and the storage controllers 108 of the storage system 106. The connectivity metrics 402 are used, in part, to assess the communication links 110 between the hosts 102 and the storage system 106. For example, connectivity metrics 402 may record whether a link 110 has been added or dropped, and may record an average number of IOPS issued, an associated bandwidth, or a latency.

The host connectivity database 400 may take any suitable format including a linked list, a tree, a table such as a hash table, an associative array, a state table, a flat file, a relational database, and/or other memory structure. The host connectivity database 400 may be a separate database from the performance-tracking database 300 or may be incorporated into the performance-tracking database 300. Similar to the performance-tracking database 300, the work of creating and maintaining the host connectivity database 400 may be performed by any component of the storage architecture 100, such as one or more storage controllers 108 and/or a performance monitor 118.

In block 206, the storage system 106 detects a triggering event that causes the system 106 to evaluate the possibility of reassigning the volumes 114. The triggering event may be any occurrence that indicates one or more volumes 114 may benefit from being assigned to another storage controller 108. Triggers may be fixed, user-specified, and/or developer-specified. In many embodiments, triggering events include a time interval such as an elapsed time since the last reassignment. For example, the volumes 114 assignment may be reevaluated every hour. In some such embodiments, the time interval is increased if the storage system 106 is experiencing heavy load to avoid disrupting the pending data transactions. Other exemplary triggering events include adding or removing a host 102, a storage controller 108, and/or a volume 114. In a further example, a triggering event includes a storage controller 108 experiencing activity that exceeds a threshold. Other triggering events are both contemplated and provided for.

In block 208, upon detecting a triggering event, the storage system 106 analyzes the performance-tracking database 300 to determine whether a change in volume 114 ownership would improve the overall performance of the storage system 106. As a number of factors affect transaction response times, the determination may analyze any of a wide variety of system aspects. The analysis may consider performance benefits, limitations on possible assignments, and/or other relevant considerations.

In an exemplary embodiment, the storage system 106 evaluates the load on the storage controllers 108 to determine whether a load imbalance exists. A load imbalance means that one storage controller 108 is devoting more resources to servicing transactions than another controller 108 and may suggest that the more heavily loaded controller 108 is creating a bottleneck. By transferring some of the transactions (and thereby some of the load) to another controller 108, delays caused by an overtaxed storage controller 108 may be improved. A load imbalance may be detected by comparing performance metrics 302 such as IOPS, bandwidth, cache utilization, and/or processor utilization across volumes 114, storage controllers 108, and or hosts 102 to determine those components that are unusually busy or unusually idle. Additionally or in the alternative, performance metrics 302 may be compared against a threshold to determine components that are unusually busy or unusually idle.

In another exemplary embodiment, the analysis includes evaluating exchanges on the inter-controller bus 116 to determine whether a storage controller 108 is forwarding an unusually large amount of transactions directed to a volume 114. If so, transaction response times may be improved by making the storage controller an owner of the volume 114 and thereby reducing the number of forwarded transactions. Other techniques for determining whether to reassign volumes 114 are both contemplated and provided for.

In a final example, the analysis includes determining the performance impact of reassigning a particular volume 114 based on the performance metrics 302 of the performance-tracking database 300. In some embodiments, volumes 114 are considered for reassignment in order according to transaction load, with volumes 114 experiencing an above-average number of transactions considered first for reassignment. Determining the performance impact may include determining whether volumes 114 may be reassigned at all. For example, some volumes 114 may be permanently assigned to a storage controller 108 and are unable to be reassigned. Some volumes 114 may only be assignable to a subset of the available controllers 106. Some volumes 114 may have dependencies that make them inseparable. For example, a volume 114 may be inseparable from a corresponding metadata volume.

Any component of the storage architecture 100 may perform or assist in determining whether to reassign volumes 114. In many embodiments, a storage controller 108 of the storage system 106 makes the determination. For example, a storage controller 108 experiencing an unusually heavy transaction load may trip the triggering event of block 206 and may determine whether to reassign volumes as described in block 208. In another example, a storage controller 108 experiencing an unusually heavy load may request a less-burdened storage controller 108 to determine whether to reassign the volumes 114. In a final example, the determination is made by another component of the storage system 106 such as the performance monitor 118.

In block 210, candidate volumes 114 for reassignment are identified based, at least in part, on the analysis of block 208. In block 212, the storage system 106 determines which hosts 102 have access to the candidate volumes 114. The storage system 106 may include one or more access control data structures such as an Access Control List (ACL) data structure or Role-Based Access Control (RBAC) data structure that defines the access permissions of the hosts 102. Accordingly, the determination may include querying an access control data structure to determine those hosts 102 that have access to a candidate volume 114.

In block 214, for each host 102 having access to a volume 114, the data paths between the host 102 and volume 114 are evaluated to determine whether a change in storage controller ownership will positively or negative impact connectivity. In particular, the connectivity metrics 402 of the host connectivity database 400 are analyzed to determine whether the data path, (including the links 110 and the inter-controller bus 116, if applicable) to the original owning controller 108 or new owning controller 108 has better connectivity. By considering the connectivity metrics 402, a number of conditions outside of the storage system 106 that are otherwise unaddressable can be corrected, or at least mitigated.

Referring to FIG. 5, in a simple example, a host 102A may lose connectivity with a single storage controller 108A. The respective connectivity metric 402 records the corresponding link 110A as lost. The host 102A may still communicate with the storage system 106 via link 110B that allows the host 102 to send transactions directed to volumes 114 owned by the storage controller 108A to another storage controller 108B. The transactions are then forwarded by controller 108B across the inter-controller bus 116 to controller 108A. However, because of the transaction forwarding, this data path may have reduced connectivity. The connectivity impact may cause the storage system 106 to cancel a change in ownership of a volume 114 to storage controller 108A that would otherwise occur for load balancing reasons.

In some embodiments, the evaluation of the data paths includes a performance analysis using the performance-tracking database 300 to determine the performance impact using a data path with reduced connectivity. For example, in an embodiment, a change in storage controller ownership may be modified based on a host 102A with reduced connectivity only if the host 102A sends at least a threshold number of transactions to the affected volumes 114. Additionally or in the alternative, a change in storage controller ownership may occur solely based on a host 102A with reduced connectivity if the host 102A sends at least a threshold number of transactions to the affected volumes 114. For example, if host 102A initiates a large number of transactions directed to a volume 114 owned by storage controller 108A, the volume 114 may be reassigned to storage controller 108B at least until link 110A is reestablished.

In addition to link status, the connectivity metrics 402 may include quality of service (QoS) factors such as bandwidth, latency, and/or signal quality of the links 110. Other suitable connectivity metrics 402 include the low-level protocol of the link (e.g., iSCSI, Fibre Channel, SAS, etc.) and the speed rating of the protocol (e.g., 4 Gb Fibre Channel, 8 Gb Fibre Channel, etc.). In these examples, the QoS connectivity metrics 402 are considered when determining whether to reassign volumes 114 to storage controllers 108. In one such example, host 102B only has a single link 110 to a first storage controller 108A, but has several links 110 to a second storage controller 108B that can operate in parallel to offer increased bandwidth. Therefore, volumes 114 that are heavily utilized by host 102B may be transferred to the second storage controller 108B to take advantage of the increased bandwidth.

In block 216, the candidate volumes are transferred from the original storage controller 108 to a new storage controller 108. In the example of FIG. 6, volumes 114A and 114B are reassigned from storage controller 108A to 108B, and volume 114C is reassigned from storage controller 108B to storage controller 108A. Volume 114D remains assigned to storage controller 108B. In some embodiments, the storage controller (e.g., controller 108A) that is relinquishing ownership continues to process transactions that are already queued within the storage controller but forwards any subsequent transactions to the new owner (e.g., storage controller 108B). In other embodiments, the storage controller 108 that is relinquishing ownership transfers all pending and future transactions to the new owner to complete. Should the transfer of a volume 114 fail, the transfer may be retried and/or postponed with the relinquishing storage controller 108 retaining ownership in the meantime.

Referring to block 218 of FIG. 2, the storage system 106 communicates the change in storage controller ownership of the volumes 114 to the hosts 102. The method of communicating this change is often particular to the communication protocol between the hosts 102 and the storage system 106. In some examples, the communication protocol defines a number of Unit Attention (UA) messages that may be transmitted from the storage system 106 to the hosts 102. Rather than initiating communications, a typical UA message is provided as a response to a transaction request sent by the host 102. An exemplary UA interrupts the host's current transaction request to inform the host 102 that ownership of the volumes 114 of the storage system 106 has changed. In response, the host 102 may restart the transaction by resending the transaction request to the new owner of the respective volume 114. The UA may or may not specify the new ownership, and thus, a further exemplary UA message merely informs the host 102 that an unspecified change to the storage system 106 has occurred. In this example, it is left to the host 102 to begin a discovery phase to rediscover the volumes 114 of the storage system 106. Suitable UAs include the SCSI 2A/06 “Asymmetric Access State Changed” code.

This technique enables to storage system 106 to evaluate both internal and external factors that affect storage system performance in order to determine optimal allocation of volumes 114 to storage controllers 108. As a result, transaction throughput may be improved and response times reduced compared to conventional techniques. The described method 200 relies in part on a host connectivity database 400 to evaluate the connectivity of the data paths between the hosts 102 and the volumes 114. In some embodiments, the storage system 106 uses the UA messages of block 218, and more specifically, the host 102 response to the UA messages to update the host connectivity database for subsequent iterations of the method 200. This may allow the method 200 to be performed by the storage system 106 without changing any software or hardware configurations at the hosts 102.

In that regard, referring to block 220, the storage system 106 receives a host 102 response to the change in ownership and evaluates the response to determine a connectivity metric 402. In an exemplary embodiment, a UA transmitted from the storage system 106 to the hosts 102 in block 218 informing the hosts 102 of the change in ownership causes the hosts 102 to enter a discovery phase. In the discovery phase, a host 102 sends a Report Target Port Groups (RTPG) message from each HBA 104 across at least one link 110 to each connected storage controller 108.

The storage controller 108, a performance monitor 118, or another component of the storage system uses the RTPG to determine a connectivity metric 402 such as whether a link 110 has been added or lost. The storage system 106 may track which controllers 108 have received messages from which hosts 102 using fields of the RTPG message and/or storage system's own logs. In some embodiments where a host 102 transmits an RTPG command to each connected storage controller 108, the storage system 106 determines that only those storage controllers 108 that received an RTPG from a given host 102 have at least one functioning link 110 to the host 102. In some embodiments, the storage system 106 determines that a link 110 has been added when a storage controller 108 receives an RTPG from a host 102 that it did not receive an RTPG from in a previous iteration. In some embodiments, the storage system 106 determines that a link 110 has lost a connection when a storage controller 108 fails to receive an RTPG from a host 102 that it received an RTPG from in a previous iteration. Thus, by comparing RTPG messages received over time, the storage system 106 can determine new links 110 or links 110 that have lost connections. By comparing RTPGs across storage controllers 108, the storage system 106 can distinguish between hosts 102 that have lost links 110 to some of the storage controllers 108 and hosts 102 that have disconnected completely. In some embodiments, the storage system 106 alerts a user when links 110 are added or lose connection or when hosts 102 are added or lost.

The storage system 106 may also determine QoS metrics based on the RTPG messages such as latency and/or bandwidth, even where the message does not include explicit connection information. For example, the storage system 106 may determine a latency measurement associated with a link 110 by examining a timestamp within the RTPG message. Additionally or in the alternative, the storage system 106 may determine a relative latency by comparing the time when a single host's RTPGs were received at different storage controllers 108. An RTPG received much later may indicate a link 110 with higher latency. In some embodiments where hosts 102 send an RTPG over each link 110 in multi-link configurations, the storage system 106 can determine based on the number of RTPG messages received how may links exist between a host 102 and a storage controller 108. From this, the storage system 106 can evaluate bandwidth, redundancy, and other effects of the multi-link 110 data path. Other information about the link 110, such as the transport protocol, speed, or bandwidth, may be determined from the link 110 itself, rather than the RTPG message. It is understood that these are merely examples of connectivity metrics 402 that may be determined in block 220, and other connectivity metrics are both contemplated and provided for. Referring to block 222, the host connectivity database 400 is updated based on the connectivity metrics 402 to be used in a subsequent iteration of the method 200.

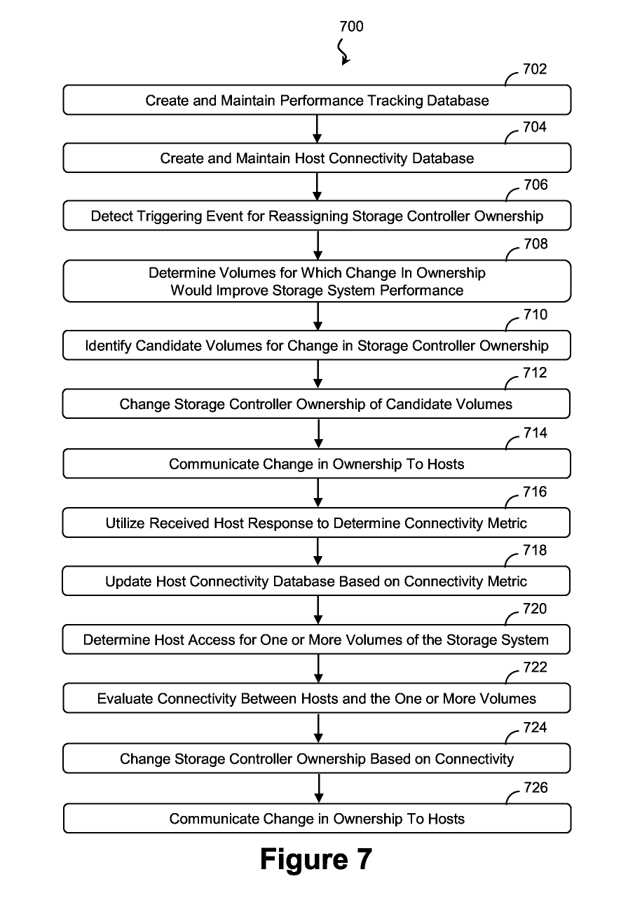

In the foregoing method 200, the reassignment of volumes 114 to storage controllers 108 is a single-pass process. In other words, a single change in storage controller ownership is made based on both overall performance and connectivity considerations. The obvious advantage to a single-pass process is a reduction in the number of changes in storage controller ownership. However, in many embodiments, there is little overhead involved in reassigning volumes 114 and multiple reassignments do not negatively impact performance. Accordingly, in such embodiments, a two-pass reassignment may be performed. The first pass determines and implements a change in storage controller ownership in order to improve system performance (e.g., balance load), either with or without connectivity considerations. When the first pass changes are implemented, the host responses are used to update the host connectivity database 400. A second pass reassignment may then be made based on up-to-date connectivity information. FIG. 7 is a flow diagram of a two-pass method 700 of reassigning volumes among storage controllers according to aspects of the present disclosure. It is understood that additional steps can be provided before, during, and after the steps of method 700, and that some of the steps described can be replaced or eliminated for other embodiments of the method.

Block 702-710 may proceed substantially similar to blocks 202-210 of FIG. 2, respectively. In that regard, the storage system 106 may maintain a performance-tracking database 300 and a host connectivity database 400, detect a triggering event, determine volumes for which a change in ownership would improve storage system performance, and identify the candidate volumes for change in ownership. Optionally, the storage system 106 may determine the connectivity impact on the hosts 102 of the change in ownership as described in blocks 212 and 214 of FIG. 2. In block 712, the candidate volumes are transferred from the original storage controller 108 to a new storage controller 108 substantially as described in block 216 of FIG. 2. In blocks 712-718, the storage system 106 communicates the change in ownership to the hosts 102, receives a host response (e.g., an RTPG message), determines a connectivity metric 402 based on the host response, and updates the host connectivity database 400 accordingly. Each of blocks 712-718 may be performed substantially similar to blocks 216-222 of FIG. 2, respectively. This completes the first pass of the volume 114 reassignment.

The storage system 106 then begins the second pass where another reassignment is performed based on connectivity considerations. Referring to block 720, the storage system 106 determines host-volume access for the volumes 114 of the storage system 106. In some embodiments, the storage system 106 determines host-volume access for all the volumes 114 of the storage system 106. In alternative embodiments, the storage system 106 only determines host-volume access for those volumes 114 reassigned in block 714. The storage system 106 may query an access control data structure such as an ACL or RBAC data structure to determine those hosts 102 that have access to a particular volume 114.

In block 722, the storage system 106 evaluates the data paths between the hosts 102 and volumes 114 to determine volumes 114 for which a change in ownership would improve connectivity with the hosts 102. This evaluation may be performed substantially similar to the evaluation of block 214 of FIG. 2. One difference is that because the host connectivity database 400 was updated in block 718 after the first pass, the connectivity metrics 402 used in the evaluation of block 722 may be more current. In block 724, the storage controller ownership may be reassigned based on the results of the connectivity evaluation of block 722 and may proceed substantially similar to block 712. In block 726, the storage system 106 may communicate the change in storage controller ownership to the hosts 102 substantially as described in block 714.

Embodiments of the present disclosure can take the form of a computer program product accessible from a tangible computer-usable or computer-readable medium providing program code for use by or in connection with a computer or any instruction execution system. For the purposes of this description, a tangible computer-usable or computer-readable medium can be any apparatus that can store the program for use by or in connection with the instruction execution system, apparatus, or device. The medium can be an electronic, magnetic, optical, electromagnetic, infrared, or a semiconductor system (or apparatus or device). In some embodiments, one or more processors running in one or more of the hosts 102 and the storage system 106 execute code to implement the actions described above.

Thus, the present disclosure provides a system and method for optimizing the allocation of volumes to storage controllers. In some embodiments, a method is provided. The method comprises: during a discovery phase, determining a connectivity metric from a device discovery command; recording the connectivity metric into a data structure that identifies a plurality of hosts and a plurality of storage controllers of a storage system; and, in response to the determining of the connectivity metric, changing a storage controller ownership of a first volume to improve connectivity between a host of the plurality of hosts and the first volume. In some such embodiments, the method further comprises: changing a storage controller ownership of a second volume to balance load among the plurality of storage controllers and transmitting an attention command to the host based on the changing of the storage controller ownership of the second volume, wherein the discovery phase is based at least in part on the attention command.

In further embodiments, a storage system is provided that comprises: a processing device; a plurality of volumes distributed across one or more storage devices; and a plurality of storage controllers in communication with a host and with the one or more storage devices, wherein the storage system is operable to: determine a connectivity metric based on a discovery command received from the host at one of the plurality of storage controllers, and change a first storage controller ownership of a first volume of the plurality of volumes based on the connectivity metric to improve connectivity to the first volume. In some such embodiments, the connectivity metric corresponds to a lost link between the host and one of the plurality of storage controllers.

In yet further embodiments, an apparatus comprising a non-transitory, tangible computer readable storage medium storing a computer program is provided. The computer program has instructions that, when executed by a computer processor, carry out: receiving a device discovery command from a host during a discovery phase of the host; determining a metric of a communication link between the host and a storage system based on the device discovery command; recording the metric in a data structure; identifying a change in volume ownership to improve connectivity between the host and a volume based on the metric; and transferring the volume from a first storage controller to a second storage controller to effect the change in volume ownership.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
during a discovery phase, determining a connectivity metric from a device discovery command;
recording the connectivity metric into a data structure that identifies a plurality of hosts and a plurality of storage controllers of a storage system; and
in response to the determining of the connectivity metric, changing a storage controller ownership of a first volume to improve connectivity between a host of the plurality of hosts and the first volume.

2. The method of claim 1 further comprising:
changing a storage controller ownership of a second volume to balance load among the plurality of storage controllers.

3. The method of claim 2 further comprising:
transmitting an attention command to the host based on the changing of the storage controller ownership of the second volume,
wherein the discovery phase is based at least in part on the attention command.

4. The method of claim 1, wherein the changing of the storage controller ownership of the first volume to improve connectivity is based on the host providing at least a threshold number of transactions directed to the first volume.

5. The method of claim 1, wherein the connectivity metric indicates that the host has lost a connection to a storage controller owner of the first volume.

6. The method of claim 5 further comprising:
alerting a user that the host has lost connectivity.

7. The method of claim 1, wherein the connectivity metric relates to at least one of a bandwidth and a latency of a communication link between the host and a storage controller owner of the first volume.

8. A storage system comprising:
a processing device;
a plurality of volumes distributed across one or more storage devices; and
a plurality of storage controllers in communication with a host and with the one or more storage devices,
wherein the storage system is operable to:
determine a connectivity metric based on a discovery command received from the host at one of the plurality of storage controllers, and
change a first storage controller ownership of a first volume of the plurality of volumes based on the connectivity metric to improve connectivity to the first volume.

9. The storage system of claim 8, wherein the storage system is further operable to:
determine a performance metric; and
change a second storage controller ownership of a second volume of the plurality of volumes based on the performance metric.

10. The storage system of claim 9, wherein the storage system is further operable to provide a unit attention (UA) message to the host in response to the change of the second storage controller ownership, and wherein UA message is configured to invoke the discovery command from the host.

11. The storage system of claim 8, wherein the connectivity metric corresponds to a lost link between the host and one of the plurality of storage controllers.

12. The storage system of claim 11, wherein the storage system is further operable to provide an alert indicating the lost link.

13. The storage system of claim 8, wherein the connectivity metric represents at least one of a bandwidth and a latency of a corresponding link.

14. The storage system of claim 8, wherein the storage system is operable to change the first storage controller ownership of the first volume further based on a load caused by the host on the first volume.

15. An apparatus comprising: a non-transitory, tangible computer readable storage medium storing a computer program, wherein the computer program has instructions that, when executed by a computer processor, carry out:
receiving a device discovery command from a host during a discovery phase of the host;
determining a metric of a communication link between the host and a storage system based on the device discovery command;
recording the metric in a data structure;
identifying a change in volume ownership to improve connectivity between the host and a volume based on the metric; and
transferring the volume from a first storage controller to a second storage controller to effect the change in volume ownership.

16. The apparatus of claim 15, wherein the change in volume ownership is a first change in volume ownership, and wherein the computer program has further instructions that carry out:
determining a performance metric of the storage system; and
identifying a second change in volume ownership to balance a load of the storage system based on the performance metric.

17. The apparatus of claim 16, wherein the computer program has further instructions that carry out:
transmitting an attention command to the host indicating the second change in volume ownership has occurred, wherein the device discovery command is sent in response to the attention command.

18. The apparatus of claim 15, wherein the metric indicates that the communication link has lost a connection.

19. The apparatus of claim 18, wherein the computer program has further instructions that carry out:
alerting a user that the communication link has lost a connection.

20. The apparatus of claim 15, wherein the metric relates to at least one of a bandwidth and a latency of the communication link.
